(19) United States
(12) Patent Application Publication
(10) Pub. No.: US 2023/0324307 A1
(43) Pub. Date: Oct. 12, 2023

(54) CIRCUIT BOARD WITH ONBOARD LIGHT SOURCES

(71) Applicant: Siemens Healthcare Diagnostics Inc., Tarrytown, NY (US)

(72) Inventors: Manish Deshpande, Newton, MA (US); Willis Howard III, Elkhart, IN (US)

(73) Assignee: Siemens Healthcare Diagnostics Inc., Tarrytown, NY (US)

(21) Appl. No.: 18/040,901

(22) PCT Filed: Aug. 10, 2021
(86) PCT No.: PCT/US2021/045374

§ 371 Date: Feb. 7, 2023

Related U.S. Application Data
(60) Provisional application No. 63/225,124, filed on Jul. 23, 2021.
(60) Provisional application No. 63/064,609, filed on Aug. 12, 2020.

(51) Int. Cl. G01N 21/78; F21V 19/00; H04N 23/74; H04N 23/56; G06T 7/90; G06T 7/00

(52) U.S. Cl. CPC G01N 21/78; F21V 19/0025; G06T 7/0002; G06T 7/90; H04N 23/56; H04N 23/74; F21Y 2115/10

(57) ABSTRACT

A reagent analyzer having a circuit board, an imaging system and a processor is disclosed. The circuit board has a substrate, and a plurality of conductive leads. The substrate has a first and a second major surface. The first major surface is opposite the second major surface. The substrate has an opening extending between the first major surface and the second major surface. The reagent analyzer also includes an imaging system having a field of view extending through the opening formed in the substrate and configured to capture an image of a wet reagent test device positioned at a read position in the field of view, the image having a plurality of pixels. The processor is configured to receive the image, and to analyze pixels of the image to determine a presence or an absence of a target constituent being in a sample applied to the wet reagent pad.

The subject application claims benefit under 35 USC § 119(e) of US provisional Application No. 63/064,609, filed Aug. 12, 2020, and US provisional Application No. 63/225,124, filed Jul. 23, 2021. The entire contents of the above-referenced patent applications are hereby expressly incorporated herein by reference.

### BACKGROUND

The inventive concepts disclosed herein generally relate to analyzers for reagent cards, and more particularly, but not by way of limitation, to an analyzer having an improved signal to noise ratio by using a circuit board having an opening and onboard light sources.

To satisfy the needs of the medical profession as well as other expanding technologies, such as the brewing industry, chemical manufacturing, etc., a myriad of analytical procedures, compositions, and tools have been developed, including lateral flow immunoassays, and the so-called “dip-and-read” type reagent test devices. Regardless of whether lateral flow immunoassays, or dip-and-read test devices are used for the analysis of a biological fluid or tissue, or for the analysis of a commercial or industrial fluid or substance, the general procedure involves a test device coming in contact with the sample or specimen to be tested, and manually or instrumentally analyzing the test device.

A lateral flow immunoassay is a diagnostic device used to confirm the presence or absence of a target analyte. Lateral flow immunoassays typically contain a flow path which conveys a sample past a control line position and a test line position. A control line at the control line position confirms the test is working properly, and a test line at the test line position provides the result of the lateral flow immunoassay. Lateral flow immunoassays are developed to be used in a dipstick format or in a housed test format. Both dipsticks and housed tests work in a similar way, and generally fall within one of two categories: sandwich assays – a positive test is represented by the presence of a colored line at the test line position; and competitive assays – a positive test is represented by the absence of a colored line at the test line position.

Dip-and-read reagent test devices enjoy wide use in many analytical applications, especially in the chemical analysis of biological fluids, because of their relatively low cost, ease of usability, and speed in obtaining results. In medicine, for example, numerous physiological functions can be monitored merely by dipping a dip-and-read reagent test device into a sample of body fluid or tissue, such as urine or blood, and observing a detectable response, such as a change in color or a change in the amount of light reflected from, or absorbed by the test device.

Many of the dip-and-read reagent test devices for detecting body fluid components are capable of making quantitative, or at least semi-quantitative, measurements. Thus, by measuring the detectable response after a predetermined time, a user can obtain not only a positive indication of the presence of a particular constituent in a test sample, but also an estimate of how much of the constituent is present. Such dip-and-read reagent test devices provide physicians and laboratory technicians with a facile diagnostic tool, as well as with the ability to gauge the extent of disease or bodily malfunction.

Illustrative of dip-and-read reagent test devices currently in use are products available from Siemens Healthcare Diagnostics Inc., under the trademark MULTISTIX, and others. Immunochemical, diagnostic, or serological test devices such as these usually include one or more carrier matrix, such as absorbent paper, having incorporated therein a particular reagent or reactant system which manifests a detectable response (e.g., a color change in the visible or ultraviolet spectrum) in the presence of a specific test sample component or constituent. Depending on the reactant system incorporated with a particular matrix, these test devices can detect the presence of glucose, ketone bodies, bilirubin, urobilinogen, occult blood, nitrite, and other substances. A specific change in the intensity of color observed within a specific time range after contacting the dip-and-read reagent test device with a sample is indicative of the presence of a particular constituent and/or its concentration in the sample. Some other examples of dip-and-read reagent test devices and their reagent systems may be found in U.S. Pat. Nos. 3,123,443; 3,212,855; and 3,814,668, the entire disclosures of which are hereby incorporated herein by reference.

However, dip-and-read reagent test devices suffer from some limitations. For example, dip-and-read reagent test devices typically require a technician to manually dip the test device into a sample, wait for a prescribed amount of time, and visually compare the color of the test device to a color chart provided with the test device. This process is slow and the resulting reading is highly skill-dependent (e.g., exact timing, appropriate comparison to the color chart, ambient lighting conditions, and technician vision) and may be inconsistent between two different technicians performing the same test. Finally, the act of manually dipping the test device into the sample may introduce cross-contamination or improper deposition of the test sample on the test device, such as via incomplete insertion of the test device into the sample, insufficient time for the sample to be deposited onto the test device, or having too much sample on the test device which may drip, leak, or splash on the technician’s work area, person, or clothing.

Testing tools and methods have been sought in the art for economically and rapidly conducting multiple tests, especially via using automated processing. Automated analyzer systems have an advantage over manual testing with respect to cost per test, test handling volumes, and/or speed of obtaining test results or other information.

Automated instruments which are currently available for instrumentally reading individual reagent test devices, such as lateral flow immunoassays, or dip-and-read reagent test devices, or reagent strips, (e.g., CLINITEK STATUS reflectance photometer, manufactured and sold by Siemens Healthcare Diagnostics, Inc.) require each test device to be manually loaded into the automated instrument after contacting the test device with specimen or sample to be tested. Manual loading requires that the reagent test device be properly positioned in the automated instrument within a limited period of time after contacting the solution or substance to be tested. At the end of the analysis, used reagent test devices are removed from the instrument and disposed of in accordance with applicable laws and regulations.

Another development is the introduction of multiple-profile reagent cards and multiple-profile reagent card automated analyzers. Multiple-profile reagent cards are essentially card-shaped test devices which include multiple reagent-impregnated matrices or pads for simultaneously or sequentially performing multiple analyses of analytes, such as the one described in U.S. Pat. No. 4,526,753, for example, the entire disclosure of which is hereby incorporated herein by reference. The reagent pads on the multiple-profile reagent card are typically arranged in a grid-like arrangement and spaced at a distance from one another so as to define several rows and columns of reagent pads. Adjacent reagent pads in the same row may be referred to as a test strip, and may include reagents for a preset combination of tests that is ran for each sample, for example.

Multiple-profile reagent cards result in an efficient, economical, rapid, and convenient way of performing automated analyses. An automated analyzer configured to use multiple-profile reagent cards typically takes a multiple-profile reagent card, such as from a storage drawer, or a cassette, and advances the multiple-profile reagent card through the analyzer over a travelling surface via a card moving mechanism, typically one step at a time so that one test strip (or one row of reagent pads) is positioned at a sample-dispensing position and/or at one or more read position. Exemplary card moving mechanisms include a conveyor belt, a ratchet mechanism, a sliding ramp, or a card-gripping or pulling mechanism. As the multiple-profile reagent card is moved or travels along the travelling surface and is positioned at the sample-dispensing position, one or more pipettes (e.g., manual or automatic) deposits a volume of one or more samples on one or more of the reagent pads on the reagent card. Next, the reagent pads are positioned at one or more read positions and analyzed (e.g., manually or automatically) to gauge the test result. The reagent card is placed in the field of view of an imaging system, such as an optical imaging system, a microscope, or a photo spectrometer, for example, and one or more images of the reagent pads on the card (e.g., optical signals indicative of the color of the reagent pads) is captured and analyzed. Typically, the field of view of the imaging system is relatively large to allow for the capture of multiple images of the same reagent pad as the reagent card is moved or stepped across multiple read positions in the field of view of the imaging system. The field of view encompasses multiple read positions or locations, and each reagent pad is moved in a stepwise fashion through the read positions as the reagent card travels across the field of view of the imaging system. Because the analyzer moves the card between various read positions in known intervals of time, the multiple images taken in the field of view of the imaging system allow the analyzer to determine changes in the color of the reagent pad as a result of the reagent pad reacting with the sample at each read position as a function of the time it takes the pad to be moved to the respective read position, for example. Finally, the used card is removed from the analyzer, and is disposed of appropriately.

Existing problems with optical imaging systems that are used with automated analyzers is the uneven illumination of the relatively large field of view of the optical imaging system, vignetting effect of the lens of the camera being used, and noise due to a high aspect ratio of the reagent test device, and light scattering between the test device and the imaging system. These factors may result in non-uniformity in the image. One of the requirements, however, of most colorimetric analysis modules is that the illumination intensity across the test device in the acquired image be uniform. Correction using image processing, however, does not improve the signal to noise ratio (SNR). Light scattering within existing optical imaging systems can further reduce the signal to noise ratio by introducing noise into the images.

A specular reflection is a mirror-like reflection from a surface which is unrelated to the material beneath the surface. Within analyzers, specular reflections may occur due to a wet surface of a test sample and/or a test device. When specular reflections occur, such specular reflections can confound the measurement due to bright, specular spots which are not related to a signal resulting from absorption of light within a reagent pad. Specular scattering interferes with the measurement of reflected light from reagent pads by adding an unrelated and variable signal having no relation to the analyte concentration, which leads to inaccuracy of the measurement related to analyte concentration. Crossed polarizers for reducing interference due to specular reflections are discussed in U.S. Pat. No. 4,890,926.

Accordingly, a need exists in the art for an analyzer that increases the signal to noise ratio by providing controlled illumination and reducing the effects of light scattering. It is to such a reagent analyzer that the inventive concepts disclosed herein are directed.

### SUMMARY

In one embodiment, the presently disclosed inventive concept is a reagent analyzer that addresses the deficiencies of the prior art noted above. The reagent analyzer has a circuit board, an imaging system, and a processor. The circuit board has a substrate, and a plurality of conductive leads extending on or in the substrate. The substrate has a first major surface and a second major surface, the first major surface being opposite the second major surface. The substrate has an opening extending between the first major surface and the second major surface. The reagent analyzer also includes an imaging system having a field of view extending through the opening formed in the substrate and configured to capture an image of a wet reagent test device positioned at a read position in the field of view, the image having a plurality of pixels. The processor is configured to receive the image, and to analyze pixels of the image to determine a presence or an absence of a target constituent being in a sample applied to the wet reagent pad.

### BRIEF DESCRIPTION OF THE DRAWINGS

To assist those of ordinary skill in the relevant art in making and using the inventive concepts disclosed herein, reference is made to the appended drawings and schematics, which are not intended to be drawn to scale, and in which like reference numerals are intended to refer to the same or similar elements for consistency. For purposes of clarity, not every component may be labeled in every drawing. Certain features and certain views of the figures may be shown exaggerated and not to scale or in schematic in the interest of clarity and conciseness. In the drawings:

FIG. 1 is a front elevation view of an exemplary embodiment of an analyzer according to the inventive concepts disclosed herein, showing a test device, such as a reagent card, positioned in a field of view of an imaging system thereof.

FIG. 2 is a side elevation view of the analyzer of FIG. 1.

FIG. 3 is a bottom plan view of a circuit board having an opening surrounded by onboard light sources according to the inventive concepts disclosed herein to facilitate controlled illumination of the reagent card and reduce light scattering detected by the imaging system.

FIG. 4 is a table showing exemplary power levels, x, y and z positions and angle relative to the test device for the onboard light sources according to the inventive concepts disclosed herein.

FIG. 5 is a diagram showing an illumination graph with and without optimization of the light sources according to the inventive concepts disclosed herein.

FIG. 6 is an image of an exemplary test device that can be read by the analyzer according to the inventive concepts disclosed herein.

FIG. 7 is a diagram of an exemplary embodiment of a reagent analyzer having a controller.

FIG. 8 is a flow diagram of an exemplary embodiment of a calibration routine.

FIG. 9 is a diagram showing a side elevation view of an exemplary embodiment of a reagent analyzer having a first polarizer and a second polarizer.

FIG. 10 is a diagram showing an exploded orthogonal view of the circuit board and the first polarizer.

FIG. 11 is a diagram showing the first polarizer filtering and transmitting light toward the sample, the sample/test device reflecting the light toward the second polarizer, and the second polarizer filtering and transmitting the light toward the camera.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts disclosed herein may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein “wet reagent test device” refers to a reagent device that has a volume of sample deposited thereon such that the reagent in the reagent device may react with its target constituent if such constituent is present in the sample. A wet reagent test device may also have a volume of a negative control deposited thereon.

As used herein, “reagent test device” refers to a carrier having a reagent. Exemplary reagent devices include a reagent pad of a dip and read test strip, or a control strip or a test strip of a lateral flow immunoassay.

Finally, as used herein qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

The inventive concepts disclosed herein are generally directed to analyzers for reagent cards, and more particularly, but not by way of limitation, to an analyzer that increases the signal to noise ratio by providing controlled illumination within acceptable limits and reducing the effects of light scattering. Examples of controlled illumination include, but are not limited to, uniform illumination within acceptable limits, a spot, a flash, or time-varying illumination. While the inventive concepts disclosed herein will be described primarily in connection with automatic analyzers using multiple-profile reagent cards, the inventive concepts disclosed herein are not limited to automatic analyzers or to multiple-profile reagent cards. For example, a method according to the inventive concepts disclosed herein may be implemented with a manual analyzer, or may be implemented with an automatic analyzer using a reagent test device, such as a lateral flow immunoassay, dip-and-read reagent test device, or a reel of reagent test devices on a substrate, and combinations thereof, as will be appreciated by a person of ordinary skill in the art having the benefit of the instant disclosure. Further, the inventive concepts disclosed herein may be implemented with any reagent device imaging system which has a field of view with at least one read position in the field of view.

In particular, a signal value indicative of a color of a reagent test device, such as a reagent pad, control line or test line, changes when the reagent test device gets wet. For a negative solution, the change in signal value is known (or can be measured) and therefore may become an optional offset signal value. Any change outside of the offset signal value is likely caused by a reaction with a clinical component that is being measured.

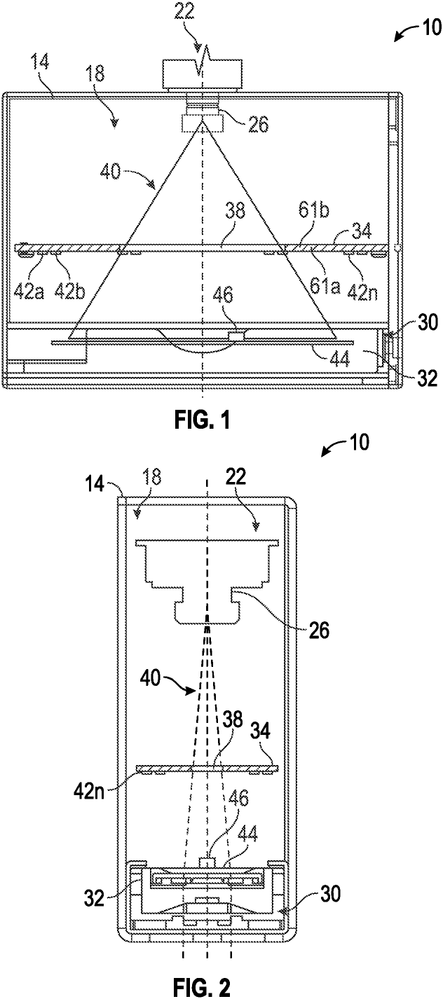

Referring now to FIGS. 1-2, shown therein is an exemplary embodiment of a reagent analyzer 10 according to the inventive concepts disclosed herein. The reagent analyzer 10 may be an automatic reagent card analyzer, for example. Exemplary embodiments of automatic reagent card analyzers are described in detail in U.S. Pat. Application Serial No. 13/712,144, filed on Dec. 12, 2012, and in PCT application No. PCT/US2012/069621, filed on Dec. 14, 2012, the entire disclosures of which are hereby expressly incorporated herein by reference.

Generally, the reagent analyzer 10 may include a housing 14 surrounding a cavity 18, an imaging system 22 comprising at least a camera 26, a sample tray 30 having a sample holder 32 positioned within the cavity 18, and a circuit board 34 having an opening 38 (also referred to as a first opening) and one or more illumination source 42a-n and positioned within the cavity 18.

The housing 14 may be formed from one or more components configured to form the cavity 18 and support the imaging system 22, the sample tray 30 and the circuit board 34. In one embodiment, the housing is opaque to visible light. In another embodiment, the house is opaque to one or more wavelength of light generated by the one or more illumination source 42a-n. In one embodiment, the housing 14 may normalize ambient light.

The imaging system 22 includes the at least one camera 26 and is supported by the housing 14. In one embodiment, the imaging system 22 may be fixed to the housing 14 or fixed at a relative distance from the sample tray 30, for example. The imaging system 22 and/or the camera 26 may include one or more lens with a focal length selected to provide a field of view 40 to include at least the opening 38 of the circuit board 34.

The imaging system 22 may be implemented and function as any desired reader such that the field of view 40 of the imaging system 22 includes substantially the entire opening 38 of the circuit board 34, for example. The imaging system 22 may be supported at a location above, below, or beside the sample tray 30. In some embodiments, the field of view 40 may extend in a linear direction from the imaging system 22 to the opening 38. In other embodiments, the field of view 40 may extend in a non-linear direction from the imaging system 22 to the opening 38 due to the presence of one or more optical steering component in the field of view 40. Exemplary optical steering components include mirror(s), lens(es), beam splitter(s), or combinations thereof. The imaging system 22 may be configured to detect or capture an image or an optical signal indicative of a reflectance value or a color value of a reagent pad (shown in FIG. 6 and discussed in more detail below) positioned in the field of view 40 of the imaging system 22, for example. It is to be understood, however that in some exemplary embodiments, the field of view 40 of the imaging system 22 may include only a portion of the opening 38 of the circuit board 34. The camera 26 of the imaging system 22 may include any desired digital or analog imager, such as a digital camera, an analog camera, a CMOS imager, a diode, and combinations thereof. The imaging system 22 may also include a lens system, optical filters, collimators, diffusers, or any other optical-signal processing devices, for example. Further, the imaging system 22 is not limited to an optical imager in the visible spectrum, and may include an infrared imaging system, an ultra-violet imaging system, a microwave imaging system, an X-ray imaging system, and/or other desired imaging systems, for example. Non-exclusive examples of the imaging system 22 include optical imaging systems, spectrophotometers, gas chromatographs, microscopes, infrared sensors, and combinations thereof, for example.

In one embodiment, the imaging system 22 includes at least one camera 26 and lens wherein the at least one camera 26 is an OnSemi MT9D131 CMOS sensor (ON Semiconductor, Phoenix, Arizona) and the lens is a DSL949 Sunex lens (Sunex Inc., Carlsbad, CA), both configured to maintain a large field of view 40 while keeping geometric image distortion low, thereby providing a resolution of 1600 pixels by 1200 pixels wherein each pixel depicts approximately a 0.065 mm square area of the sample tray 30 and/or the sample holder 32.

The sample tray 30 may be configured to adjust the location of the sample holder 32 within the field of view 40. The sample holder 32 may be configured to receive at least one of test device 44, which may be a reagent card and a reagent card cassette, each having a sample 46. The sample 46 may be any bodily fluid, tissue, or any other chemical or biological sample, and combinations thereof, such as urine, saliva, or blood, for example. The sample 46 may be in liquid form and may contain one or more target constituents such as bilirubin, ketones, glucose, or any other desired target constituent, for example.

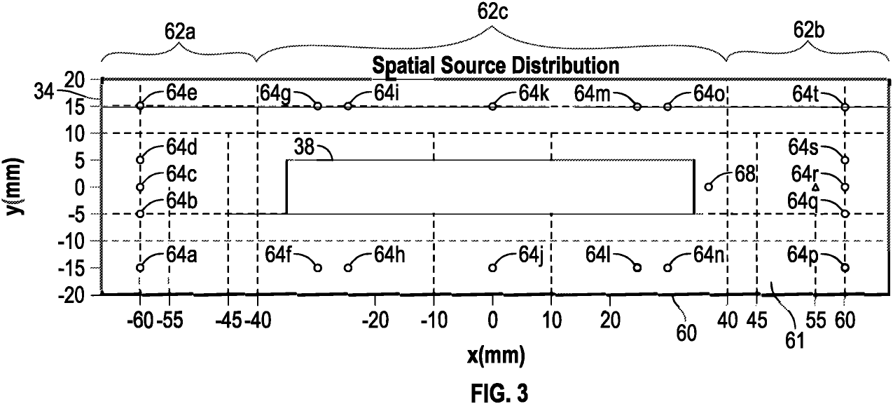

The circuit board 34 having the opening 38 may be positioned within the cavity 18 and interposed between the imaging system 22 and the sample tray 30 such that the field of view 40 of the imaging system 22 is substantially unobstructed from the sample holder 32, the test device 44, and/or the sample 46. The circuit board 34 is described in FIG. 3 and in more detail below. In one embodiment, the circuit board 34 is positioned at a fixed location between the imaging system 22 and the sample tray 30; however, in another embodiment, the circuit board 34 may be adjusted to varying locations between the imaging system 22 and the sample tray 30. If the circuit board 34 is adjustable, a calibration routine 170 (described below) would have to be performed after any adjustment.

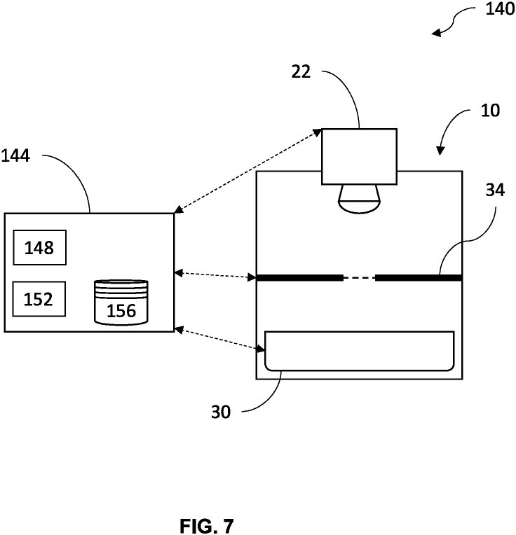

The illumination source 42a-n may be implemented as one or more of a light emitting diode, a light bulb, a laser, an incandescent bulb or tube, a fluorescent light bulb or tube, a halogen light bulb or tube, or any other desired light source or object configured to emit an optical signal having any desired intensity, wavelength, frequency, or direction of propagation, for example. The illumination source 42a-n may be attached to the circuit board 34 and may be oriented such that substantially the entire field of view 40 of the imaging system 22 is illuminated by the illumination source 42a-n. In some exemplary embodiments, the illumination source 42a-n may be operably coupled with a controller 144 (see FIG. 7 - described in detail below) so that control and/or power signals may be supplied to the illumination source 42a-n by the controller 144. Desirably, the intensity of the optical signal emitted by the illumination source 42a-n is maintained substantially constant through the operation of the reagent analyzer 10, such as by control and power signals supplied by the controller 144. In one embodiment, the optical signals emitted by the illumination source 42a-n may be conditioned or processed by one or more optical or other systems (not shown), such as filters, diffusers, polarizers, lenses, lens systems, collimators, and combinations thereof, for example.

In some exemplary embodiments the one or more illumination source 42a-n may be implemented, such as a first illumination source 42a and a second illumination source 42b, and the first illumination source 42a and the second illumination source 42b may have different locations and/or orientations thereby causing the first illumination source 42a and the second illumination source 42b to cooperate to illuminate substantially the entire field of view 40 of the imaging system 22. (e.g., substantially the entire sample holder 32 and/or sample 46). The first illumination source 42a and the second illumination source 42b may emit optical signals having different illumination intensities, for example.

In one embodiment, the sample holder 32 may be adapted to accept the test device 44 in the form of a reagent card cassette having one or more multiple-profile reagent cards therein, for example. Each reagent card (detailed below) may include a substrate and one or more reagent pads positioned thereon, or otherwise associated therewith. In an exemplary embodiment, the reagent pads may include fluidic or microfluidic compartments (not shown).

Each reagent pad may include a reagent configured to undergo a color change in response to the presence of a target constituent such as a molecule, cell, or substance in the sample 46 of a specimen deposited on the reagent pad. The reagent pads may be provided with different reagents for detecting the presence of different target constituents. Different reagents may cause one or more color change in response to the presence of a certain constituent in the sample 46, such as a certain type of analyte. The color developed by a reaction of a particular constituent with a particular reagent may define a characteristic discrete spectrum for absorption and/or reflectance of light for that particular constituent. The extent of color change of the reagent and the sample 46 may depend on the amount of the target constituent present in the sample 46, for example.

The presence and concentrations of these target constituents in the sample 46 may be determinable by an analysis of the color changes undergone by the one or more reagent pads at predetermined times after application of the sample 46 to the reagent pads and/or at predetermined read positions in the field of view of the imaging system 22, for example. This analysis may involve a color comparison of each reagent pad to itself at different time periods after application of the sample 46 and/or at different read positions in the field of view 40 of the imaging system 22.

Based upon an analysis of a magnitude of the optical signal detected by the imaging system 22 the sample 46 may be assigned to one of a number of categories, e.g., a first category corresponding to no target constituent present in the sample 46, a second category corresponding to a small concentration of target constituent present in the sample 46, a third category corresponding to a medium concentration of target constituent present in the sample 46, and a fourth category corresponding to a large concentration of target constituent present in the sample 46, for example.

Further, the imaging system 22 may detect an optical signal indicative of a color or a reflectance value of a reagent pad and/or a test strip at any time interval after a volume of sample 46 has been dispensed on the test device 44, e.g., the reagent pad and/or test strip, and regardless of location of the particular reagent pad and/or test strip, for example. In one exemplary embodiment, a video, or a sequence of images may be captured of the reagent pad and/or test strip at a variety of time intervals after a volume of sample 46 is deposited on the reagent pad and/or test strip.

The imaging system 22 may be operated intermittently, continuously, or periodically, to detect one or more reflectance signals indicative of the color or the reflectance value of the one or more test devices 44, e.g., reagent pads, at any time and at any position in the field of view of the camera 26, for example. In some exemplary embodiments, the imaging system 22 may capture an image indicative of the color or the reflectance value of the test device 44, e.g., the reagent pad, prior to any sample 46 being deposited onto the reagent pad, or at any known time after a volume of sample 46 has been deposited onto the reagent pad, for example.

Referring now to FIG. 3, shown therein is a bottom plan view of the circuit board 34 having the opening 38 surrounded by one or more illumination source 42a-n according to the inventive concepts disclosed herein to facilitate controlled illumination of the sample holder 32 and/or sample 46 and reduce light scattering detected by the imaging system 22. The controlled illumination will be described herein by way of example as uniform illumination across an extent, i.e., length and width, of the sample holder 32 and/or sample 46 within acceptable limits. It should be understood, however, that the present disclosure is not limited to uniform illumination. The circuit board 34 is comprised of a substrate 60 having a bottom surface 61a and a top surface 61b, a plurality of conductive leads extending on or in the substrate 60, and the opening 38 extending between the bottom surface 61a and the top surface 61b.

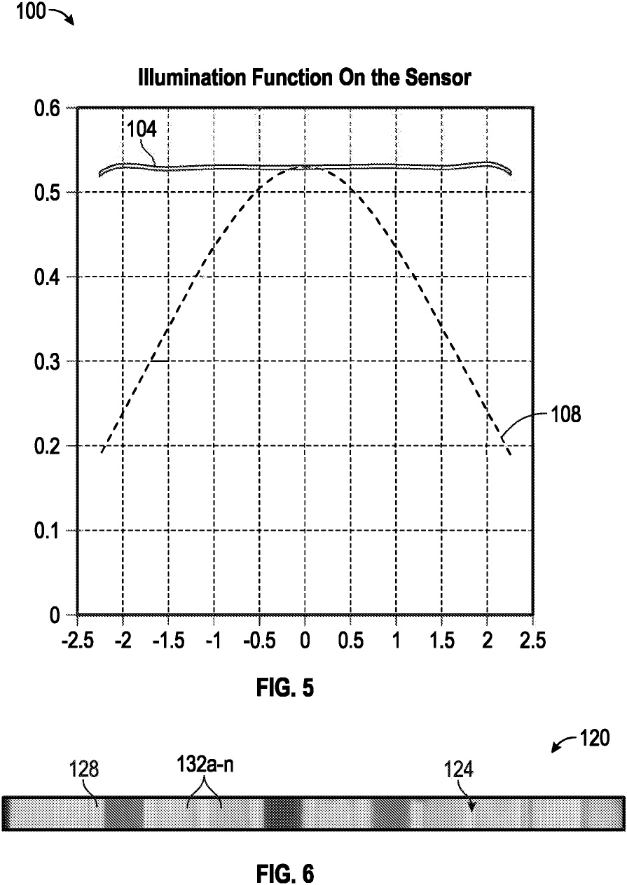

The circuit board 34 as shown in FIG. 3 depicts the bottom surface 61a of the circuit board 34 having one or more illumination source 42a. As placed within the reagent analyzer 10, the bottom surface 61a is oriented to face the sample tray 30 such that light produced by the one or more illumination source 42a-n may be directly provided on the sample holder 32 and/or sample 46. The illumination sources 42a-n are connected to the plurality of conductive leads of the circuit board 34 such that the conductive leads provide electricity to each illumination source 42a-n. In one embodiment, the circuit board 34 further includes illumination source circuitry (not shown) connected to the plurality of conductive leads and configured to apply electricity independently to each illumination source 42a-n. For example, the illumination source circuitry may be configured to supply a first power to a first illumination source 42a and a second power to a second illumination source 42b wherein the first power and the second power are different, thereby causing a difference in illumination intensity across the sample. The illumination sources 42a-n are arranged such that the illumination intensity across the field of view 40 of the camera 26 is substantially uniform, thereby increasing accuracy of readings of color changes of the reagent pads as the reagent pads are illuminated with a substantially uniform intensity (depicted in more detail below and in FIG. 5). The substrate 60 of circuit board 34, as shown in FIG. 3, is substantially planar thereby causing each of the one or more illumination source 42a-n to be a similar distance from the sample tray 32. Depending upon the location of the illumination source 42a-n relative to the sample 46, the distance between the illumination source 42a-n and the sample 46 may be different for certain of the illumination sources 42a-n. However, in other embodiments, the circuit board 34 may be non-planar thereby causing one of more of the illumination source 42a-n to be located at different distances from the sample tray 32. In one embodiment, one or more illumination source 42a-n may be affixed to a standoff (not shown) where each standoff is affixed to the circuit board 34 and provides one or more conductive paths to a particular one of the illumination source 42a-n. When a standoff is used, this causes a portion of the one or more illumination source 42a-n to be closer to the sample 46 and/or the sample tray 32.

In one embodiment, the substrate 60 has a first region 62a, a second region 62b opposite the first region 62a and an intermediate region 62c between the first region 62a and the second region 62b. The one or more illumination source 42an may be affixed to the substrate 60 in each of the first region 62a, second region 62b, and intermediate region 62c, or some combination thereof. In one embodiment, a first power may be applied to the one or more illumination source 42a-n within the first region 62a and within the second region 62b thereby causing the one or more illumination source 42a-n within the first region 62a and within the second region to provide a first illumination intensity and a second power may be applied to the one or more illumination source 42a-n within the intermediate region 62c thereby causing the one or more illumination source 42a-n within the intermediate region 62c to provide a second illumination intensity, the first power and the second power being different and the first illumination intensity and the second illumination intensity being different.

The opening 38 extends from the top surface 61b to the bottom surface 61a to provide an aperture for the field of view 40 of the imaging system 22 to pass through from the imaging system 22 to the sample holder 32 and provide the camera 26 with a controlled view of the test device 44 associated with the sample holder 32. The opening 38 may be further configured such that the bottom surface 61a of the circuit board 34 may include one or more illumination source 42a-n on each side of the opening 38. In one embodiment, the opening 38 is located substantially within the intermediate region 62c. In one embodiment, the opening 38 has a first major axis and a first minor axis and the sample holder 32 has a second major axis and a second minor axis wherein the first major axis is aligned with the second major axis. While the opening 38 is depicted as a rectangle in FIG. 3 for providing a controlled view of a rectangular reagent test device, it is understood that the opening 38 may be configured of any shape such that the field of view 40 is a controlled view of the sample tray 32 and the illumination source 42 can be calibrated to provide a substantially uniform illumination of the sample 46. In the example of FIG. 3, the opening 38 does not extend to an edge of the circuit board 34.

In one embodiment, the opening 38 extends to an edge of the circuit board 34 without bisecting the circuit board 34 whereas in another embodiment, the opening 38 extends through the entire circuit board 34, bisecting the circuit board into a first half and a second half, wherein the first half and the second half are mounted at separate locations and supported by the housing 14 such that the field of view 40 is a controlled view of the sample tray and the illumination source 42.

In one embodiment, shown in FIG. 3, the one or more illumination source 42a-n is a plurality of LEDs 64a-n and one or more IR LED 68a-n. The LEDs 64a-n shown in FIG. 3 include twenty (20) visible light LEDs arranged as shown in FIG. 3, and one or more IR LED 68. The LEDs 64a-n includes any LED that is needed to produce a substantially uniform light intensity across the sample holder 32 and/or reagent card or reagent cassette. The IR LED 68 may be used to apply heat to the sample 46, or identify an ID pad on the test device 44, for example. In one embodiment, the ID pad is utilized to correlate the sample on the test device supported by the sample holder 32 with a data obtained by the reagent analyzer 10.

In one embodiment, the plurality of LEDs 64a-n are selected to provide a fixed color, visible light, ultra-violet light, infrared light, or white light, or some combination thereof. In another embodiment, each LED 64a-n is positioned at an angle relative to the reagent card. In yet another embodiment, each LED 64a-n is positioned at one or more distance from the test device 44 supported by the sample holder 32 such that a first LED 64 and a second LED 64 are different distances from the test device 44 and/or the sample holder 32.

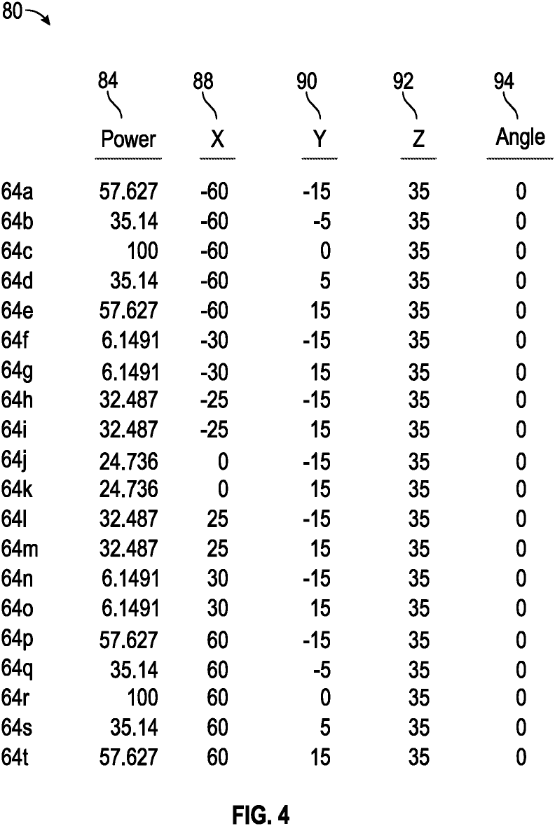

Referring now to FIGS. 4-5, shown in FIG. 4 is a table 80 showing power level 84, x-position 88, y-position 90, z-position 92, and relative angle 94, where relative angle 94 is relative to the sample holder 32 for each LED 64a-t, and shown in FIG. 5 is a diagram showing an illumination intensity graph 100 with an optimized normalized illumination intensity measurement 104 depicting optimization of the LEDs 64a-t and with an unoptimized illumination intensity measurement 108 depicting the LEDs 64a-t without optimization according to the inventive concepts disclosed herein. By adjusting the power level of each LED 64, a substantially uniform light intensity as shown in the optimized illumination intensity measurement 104 is achieved. The substantially uniform light intensity may be between 85% – 100% uniform. In the example shown in FIG. 5, the optimized normalized illumination intensity is between 85% and 95%.

Referring now to FIG. 6, shown therein is an image 120 of a portion of an exemplary test device 44 in the form of a reagent card 124 that can be read by the reagent analyzer 10 according to the inventive concepts disclosed herein.

The reagent card 124 may include a substrate 128 and one or more, or a plurality of reagent pads 132a-n positioned thereon, or otherwise associated therewith. The substrate 128 may be constructed of any suitable material, such as paper, photographic paper, polymers, fibrous materials, and combinations thereof, for example. The reagent pads 132a-n may be arranged in a grid-like configuration on the substrate 128 so as to define one or more test strip, for example. In an exemplary embodiment, the reagent pads 132a-n may include fluidic or microfluidic compartments (not shown). The reagent pads 132a-n may be spaced apart a distance from one another so that the test strips are spaced apart such that adjacent test strips and/or reagent pads 132a-n may be simultaneously positioned at separate positions within the field of view 40 of the imaging system 22, for example. The reagent card 124 may be a multiple-profile reagent card having multiple reagent pads 132a-n having different reagents and/or multiple different test strips. Further, in some exemplary embodiments, the reagent card 124 may include one or more calibration chips or reference pads, which may have no reagent and may serve as color references, for example. In another embodiment, the reagent card 124 includes an ID pad having an identifier visible under IR light.

Each reagent pad 132a-n may include a reagent configured to undergo a color change in response to the presence of a target constituent such as a molecule, cell, or substance in the sample 46 of a specimen deposited on the reagent pad 132an. The reagent pads 132a-n may be provided with different reagents for detecting the presence of different target constituents. Different reagents may cause one or more color change in response to the presence of a certain constituent in the sample 46, such as a certain type of analyte. The color developed by a reaction of a particular constituent with a particular reagent may define a characteristic discrete spectrum for absorption and/or reflectance of light for that particular constituent. The extent of color change of the reagent and the sample may depend on the amount of the target constituent present in the sample 46, for example.

The color change may be read by the imaging system 22. Signals indicative of the color of the reagent pads 132a-n may be received by the imaging system 22, which may analyze the signals and determine a change in the color of the reagent pad 132a-n as a result of the reagent pad 132a-n reacting with the volume of sample 46 deposited thereon. Such color change may be analyzed as a function of the read position of the reagent pad 132a-n when the optical signal or image indicative of the color of the reagent pad 132a-n was detected and/or as a function of the known duration of time the volume of sample 46 has been deposited onto the reagent pad 132a-n, and combinations thereof, for example. The color change may be interpreted as a quantitative, qualitative, and/or semi-qualitative indication of the presence and/or concentration or amount of a target constituent in the volume of sample 46 deposited on the reagent pad 132a-n as described above.

Referring now to FIG. 7, shown therein is an analyzer diagram 140 depicting the reagent analyzer 10 including an analyzer controller 144. The analyzer controller 144 has at least a processor 148 and a non-transitory computer readable memory 152. The memory 152 may store computer executable instructions that, when executed by the processor 148, causes the processor 148 to communicate with and/or be operable coupled to other elements of the reagent analyzer 10. While the analyzer controller 144 is depicted separately from the reagent analyzer 10, it is understood that in some embodiments, the analyzer controller 144 may be integrated into the reagent analyzer 10, such as, by way of example only, the analyzer controller 144 may be an additional component of the reagent analyzer 10 or may be integrated with another component of the reagent analyzer 10, for example, the circuit board 34.

In one embodiment, the imaging system 22 may be operably coupled with the analyzer controller 144 and/or the processor 148 so that one or more power and/or control signals may be transmitted to the camera 126 and/or to the one or more illumination source 42a-n by the controller 144, and so that one or more signals may be transmitted from the camera 126 to the processor 148, for example. The analyzer controller 144 may be configured to gauge test results as a reagent card is sampled within the reagent analyzer 10, for example, by receiving one or more signals from the camera 126. The camera 126 may be configured to detect or capture one or more optical or other signals indicative of a reflectance value of the test device 44, such as a reagent pad, and to transmit a signal indicative of the reflectance value of the test device 44, e.g., the reagent pad, to the processor 118, for example. One or more optical signals having wavelengths indicative of a reflectance value of the reagent pads and/or the test strip may be detected by the camera 126 at each read position, for example. The camera 126 may detect an optical signal indicative of a reflectance value of a reagent pad and/or test strip at any desired read position, location, or area within the field of view 40, or any other desired location or area or multiple locations or areas, for example. The signal transmitted to the processor 148 by the camera 126 may be an electrical signal, an optical signal, and combinations thereof, for example. In one embodiment, the signal is in the form of an image file having a matrix of pixels, with each pixel having a color code indicative of a reflectance value. In an exemplary embodiment, the image file may have two or more predetermined regions of pixels, each predetermined region of pixels corresponding to a read position of one of the reagent pads and/or the test strip in the field of view 40 of the camera 126. In one embodiment, the processor 148 may store the signal transmitted and or the image file in one or more database 156 and/or in the memory 152.

The processor 148 may determine the reflectance value or the color change of reagent pad and/or a test strip along with a sample (e.g., urine) disposed on the reagent pad and/or test strips based on the signals detected by the camera 126, for example. Each optical or other signal indicative of one or more reflectance value readings detected by the camera 126 may have a magnitude relating to a different wavelength of light (i.e., color). The color of the sample(s) and/or the reaction of the one or more reagents with a target constituent in a reagent pad may be determined based upon the relative magnitudes of the reflectance signals of various color components, for example, red, green, and blue reflectance component signals. For example, the color of each reagent pad may be translated into a standard color model, which typically includes three or four values or color components (e.g., RGB color model, including hue, saturation, and lightness (HLS) and hue, saturation, and value (HSV) representation of points and/or CMYK color model, or any other suitable color model) whose combination represents a particular color. In some embodiments the camera 126 may detect multiple optical signals at each read position, with each detected signal having one or more color components, such as a red component signal, a green component signal, and a blue component signal, for example, and each of the component signals may be transmitted to the processor 148. In some exemplary embodiments, the camera 126 may detect a single optical signal at each read position, and the processor 148 may translate a signal received from the camera 126 into separate color component signals such as a red component signal, a green component signal, and a blue component signal, for example.

In one embodiment, the processor 148 may calculate a calibration factor for each reagent pad at each read position by selecting or otherwise designating a reagent pad as a reference reagent pad and referencing each of the remaining reagent pad to the reference reagent pad based on a ratio of the reflectance values of the optical signal or image detected at the reference reagent pad to the respective optical signals or images detected at each reagent pad by the camera 126. Further, in some exemplary embodiments, rather than selecting a reference reagent pad, each reagent pad may be referenced to an ideal color or to a color standard for each reagent pad, as will be appreciated by persons of ordinary skill in the art.

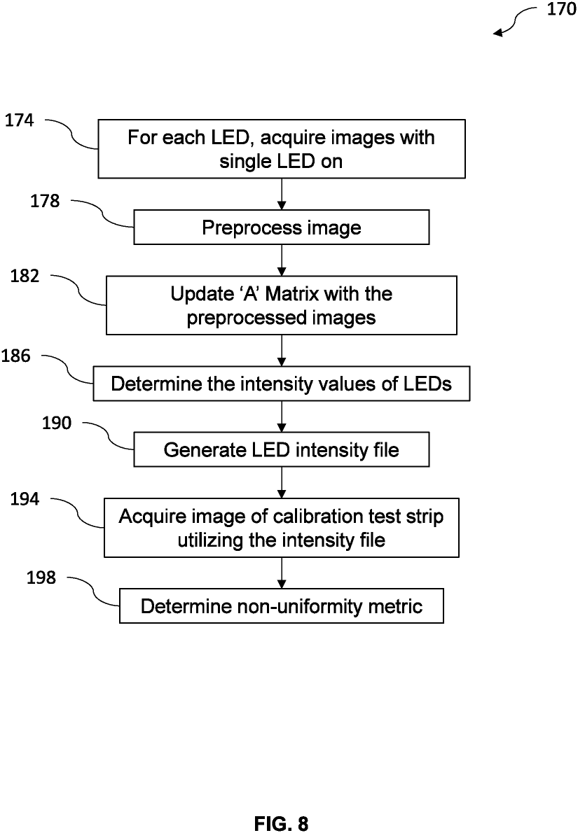

A calibration routine 170 (described below and shown in FIG. 8) may be implemented as a set of processor executable instructions or logic stored in the non-transitory computer readable medium 154, which instructions or logic when executed by the processor 148, cause the processor 148 to carry out the logic to calculate or determine the calibration factors. The calibration routine 170 may be carried out periodically, such as at a preset interval of time, with each new lot of reagent cards, as desired according to specific quality control procedures applicable to the reagent analyzer 10, and combinations thereof, for example.

Referring now to FIG. 8, shown therein is an exemplary process flow diagram of the calibration routine 170 generally consisting of the steps of: acquiring at least one image of a calibration test strip wherein for each image only one of the one or more illumination source is enabled (step 174); preprocessing the image (step 178); updating the ‘A’ matrix with the preprocessed images (step 182); determining the intensity values of each of the one or more illumination sources 42a-n (step 186); generating an illumination source intensity file (step 190); acquiring a test image of the calibration test strip using the illumination source intensity file (step 194); and determining a non-uniformity value (step 198). The calibration routine 170 is used to maximize light intensity uniformity with the minimum number of illumination sources 42a-n needed and determine an illumination source state for each illumination source 42a-n on the circuit board 34. While the calibration routine 170 is described below with each illumination source 42a-n as an LED 64a-n, it is understood that other illumination sources 42a-n may be substituted for each LED 64a-n. Further, the illumination source state for each LED may be stored as LED state data and may include data describing the LED such as intensity, power level, location, LED identifier, and/or combinations thereof, for example.

In a step 174, the camera 126 may detect a first optical signal or a first image indicative of the reflectance value of a calibration test strip positioned within the sample holder 32 and with a first LED 64a enabled while all remaining LEDs 64b-t, for example, are disabled. In an exemplary embodiment, the camera 126 may detect an image having a region of pixels having color or reflectance values depicting the color of the calibration test strip, and transmit such image to the controller 144. The camera 126 may then detect a second optical signal, different from the first optical signal, or a second image, different from the first image, indicative of the reflectance value of the calibration test strip positions within the sample holder 32 and with a second LED 64b enabled while all remaining LEDs 64a and 64c-t, for example, are disabled. The calibration test strip may be a dry reagent card having one or more dry reagent pads. Each image may include metadata stored into the image such as an LED identifier associated with the LED 64 having an enabled state, that is the LED power level is set at a value to enable the LED to generate light. Because the calibration test strip does not have a sample deposited thereon, a reaction is not occurring, and the color of the calibration test strip should be uniform across the calibration test strip. Thus, differences in the reflectance values detected in the first image and second image are due to non-uniform illumination.

In step 178, each image is preprocessed. Preprocessing may include one or more modification of each image to enable a comparison between the images. For example, preprocessing may include rotating the image and/or cropping the image such that only a portion of the image is utilized in the calibration routine 170.

In step 182, an ‘A’ matrix is updated with the preprocessed images. In the ‘A’ matrix, the i^{th} column of ‘A’ is the intensity distribution of the i^{th} LED powered to an illumination intensity, or brightness, on an object plane (e.g., a plane corresponding to a top surface of the reagent card). Vignetting V can be calibrated separately. Similarly, the i^{th} column of Aⁱ is the illumination intensity distribution of the i^{th} LED measured in unit power on an image plane.

An example ‘A’ matrix may be described in matrix form as: P_{1×m} = V_{m×m}A_{m×n}w_{1×n}, where v is a vignetting function, w are LED illumination intensity, or brightness, m is the number of grid points on the object and image planes, and n is the number of LEDs. In order to shape the image plane intensities, the weights wᵢ need to be determined.

For a single LED with a radiant intensity distribution given by L(q) placed above the object plane, an irradiance at any point (x, y) on the plane is given by:

$$d L \left(x , y\right) = L \left(θ\right) \frac{cos \left(ϕ\right)}{{r}^{2}} d x d y$$

or,

$${p}_{\text{obj}} \left(x , y\right) = L \left(θ\right) \frac{c o s \left(ϕ\right)}{{r}^{2}} ,$$

where p_{obj} is an intensity per unit area.

Illumination due to one or more LEDs supplied with uniform power tapers off at the edges of the object plane, which in the image plane, is worsened by vignetting. In order to obtain uniform illumination intensity, LED power is increased, thus increasing illumination intensity, for LEDs closer to the edge of the object plane. In one embodiment, adjusting the power of each LED is performed by using a different current limiting resistor and/or with pulse-width modulation.

In Step 186, in order to optimize the number of LEDs, the LED positions, and LED illumination intensity, or brightness, for a substantially uniform illumination within the image plane, the following optimization problem is solved for a constant vector: c_{1×m} and A^{I} = VA minimize (||A^{I}w - c||₂ + λ||w||₁) subject to 0 ≤ w ≤ wₘₐₓ. In alternative embodiments, optimization may be performed based on LED current or power, instead of LED illumination intensity, wherein the constant vector c specified the total power incident. By solving the optimization problem vignetting does not have to be separately calibrated or modeled. Further, the choice of c above enables the optimization problem to shape illumination intensity to any function, not just a uniform illumination. In one embodiment, updating the ‘A’ matrix with preprocessed images is performed by the processor 148 and may be stored in the memory 152 or the database 156. The images are then corrected for rotation, segmented, vectorized, and assembled to from the ‘A’ matrix. The optimized LED intensities are used to power each of the LEDs 64a-t and an image is taken again for evaluation. In one embodiment, the LED intensities may be determined by utilizing the CVX optimization package in MATLAB, for example, and the following code:

cvx_begin
variable w(led.count)
minimize(norm(A*w-b))
subject to
0 <= w <= 1
cvx_end

In step 190, The LED intensities are compiled into an LED intensity file, stored by the processor 148 in the memory 152, the database 156, or another suitable storage medium, or a combination thereof. The LED intensity file may store LED state data for each of the LEDs 64a-t. The LED intensities may be stored in the LED intensity file as a single LED intensity for each LED 64a-n, or as LED intensity for each channel of a desired color model. For example, a red component LED intensity, a green component LED intensity, and a blue component LED intensity may be stored for each LED 64a-t and for each channel of an RGB color model, or any other desired color model.

In step 194, the camera 126 may detect a test optical signal or obtain a test image indicative of the reflectance value of the calibration test strip positioned within the sample holder 32 and with each LED 60a-t enabled per the specific LED state data in the LED intensity file, for example. The camera 126 may detect the test image having a region of pixels having color or reflectance values depicting the color of the calibration test strip, and transmit such image to the controller 144.

In step 198, the controller 144 may evaluate the test image to determine a non-uniformity value. The non-uniformity value may be expressed as a percentage of non-uniformity of illumination intensity in the test image. In an exemplary embodiment, the non-uniformity percent is less than 5%. If the non-uniformity percent is greater than 5%, the controller 144 may indicate a failure to successfully complete the calibration routine 170, attempt to re-run the calibration routine 170, and/or some combination thereof, or do neither.

Further, as will be appreciated by persons of ordinary skill in the art, the calibration routine 170 may be carried out on one or more calibration test strips on a reagent card and the remaining test strips are used to test a sample as described above to reduce the downtime for the reagent analyzer 10, for example. In one embodiment, the reagent analyzer 10 may determine a non-uniformity value before the sample is analyzed to confirm current calibration. If the reagent analyzer 10 is determined to be uncalibrated, the calibration routine 170 may be performed.

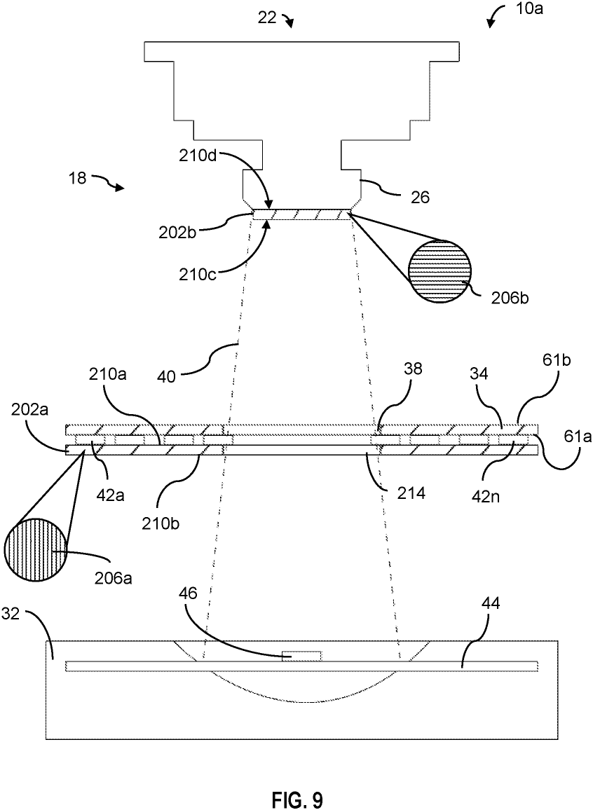

Referring now to FIG. 9, shown therein is a diagram of an exemplary embodiment of a reagent analyzer 10a that is constructed in a similar manner as the reagent analyzer 10 discussed above, with the exception that the reagent analyzer 10a has a first polarizer 202a and a second polarizer 202b. Elements that are common between the reagent analyzer 10 and the reagent analyzer 10a will be denoted with the same reference numerals. The first polarizer 202a and the second polarizer 202b may be linear absorptive (or dichroic) polarizing filters constructed of any suitable material, such as polyvinyl alcohol (PVA), cellulose triacetate (CTA), and combinations thereof, for example.

The first polarizer 202a may have a first transmission axis 206a, a first boundary 210a, a second boundary 210b opposite the first boundary 210a, and an opening 214 (also referred to herein as a second opening), and may be positioned within the cavity 18 and interposed between the circuit board 34 and the sample holder 32 such that light generated by the one or more illumination source 42a-n is provided on the first boundary 210a, and a portion of the light passes through the first polarizer 202a and the second boundary 210b. In some embodiments, the light generated by the one or more illumination source 42a-n is provided directly on the first boundary 210a.

When light is provided on the first boundary 210a, the first polarizer 202a may be configured to transmit from the second boundary 210b a portion of the light polarized linearly parallel to the first transmission axis 206a, while absorbing a portion of the light polarized linearly orthogonal to the first transmission axis 206a.

In one embodiment, the first polarizer 202a is attached to the bottom surface 61a of the circuit board 34 and covers the one or more illumination source 42a-n, whereas in another embodiment, the first polarizer 202a is mounted in the cavity 18 below the circuit board 34 and above the sampler holder 32.

The second opening 214 may be aligned with (i.e., overlapping) the first opening 38. The second opening 214 may extend from the first boundary 210a to the second boundary 210b and be aligned with the first opening 38 to permit the field of view 40 of the imaging system 22 to pass through the circuit board 34 and the first polarizer 202a from the imaging system 22 to the sample holder 32 and provide the camera 26 with a controlled view of the test device 44 associated with the sample holder 32. The second opening 214 may be configured of any shape such that the field of view 40 is a controlled view of the sample holder 32 and light generated by the one or more illumination source 42a-n is provided on the first polarizer 202a.

For example, in some embodiments, the first polarizer 202a includes multiple separate polarizers with the separate polarizers covering one or more of the one or more illumination source 42a-n. In this embodiment, the second opening 214 may be formed by an absence of the separate polarizers being aligned with the first opening 38.

The second polarizer 202b may have a second transmission axis 206b, a third boundary 210c, and a fourth boundary 210d, and may be positioned within the cavity 18 and interposed between the imaging system 22 and the circuit board 34 such that the field of view 40 of the imaging system 22 passes through the second polarizer 202b and light reflected from the sample holder 32, the test device 44, and/or the sample 46 is received by the third boundary 210c and passed to the imaging system 22 and/or the camera 26 through the second polarizer 202b and the fourth boundary 210d.

When light is provided on the third boundary 210c, the second polarizer 202b may be configured to transmit from the fourth boundary 210d a portion of the light polarized linearly parallel to the second transmission axis 206b, while absorbing a portion of the light polarized linearly orthogonal to the second transmission axis 206b.

In one embodiment, the second polarizer 202b has a fixed orientation such that the second transmission axis 206b is substantially perpendicular to the first transmission axis 206a; however, in another embodiment, the second polarizer 202b is movably (e.g., rotatably) attached to the imaging system 22 and/or the camera 26 such that the orientation of the second transmission axis 206b may be adjusted.

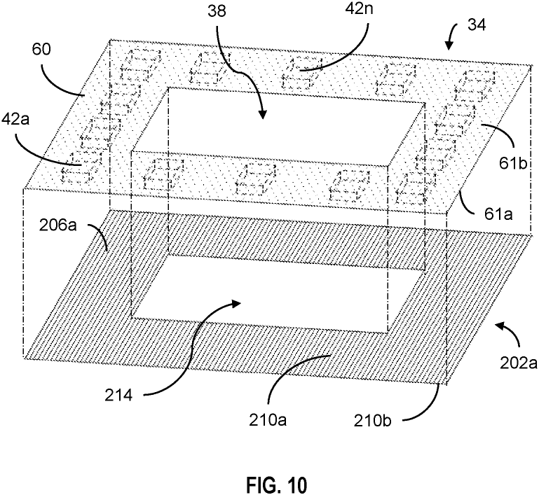

Referring now to FIG. 10, shown therein is a diagram showing an exploded orthogonal view of an exemplary embodiment of the circuit board 34 and the first polarizer 202a. The circuit board 34 is comprised of the substrate 60 having the bottom surface 61a and the top surface 61b, the first opening 38 extending between the bottom surface 61a and the top surface 61b, and the one or more illumination source 42a-n. The one or more illumination source 42a-n may be affixed to the bottom surface 61a. The first polarizer 202a is comprised of the first boundary 210a and the second boundary 210b, the first transmission axis 206a, and the second opening 214 extending between the first boundary 210a and the second boundary 210b. The second opening 214 is aligned with the first opening 38. The first polarizer 202a may be attached to the bottom surface 61a of the circuit board 34 and covers the one or more illumination source 42a-n.

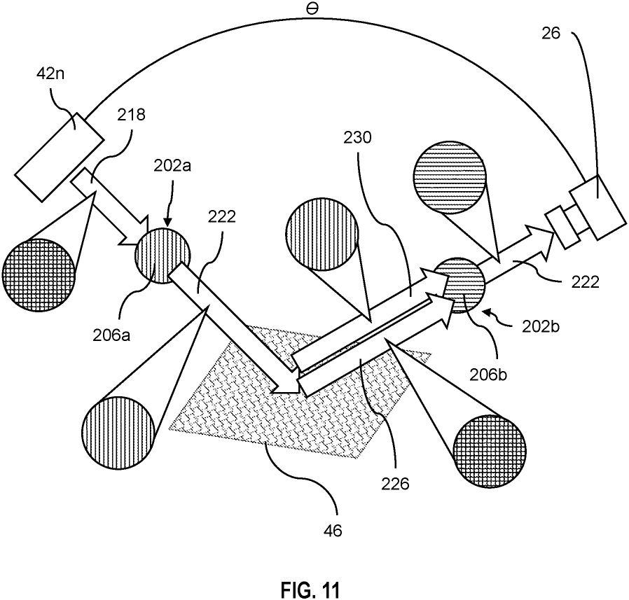

Referring now to FIG. 11, shown therein is a diagram showing the first polarizer 202a filtering unpolarized light 218 generated by the one or more illumination source 42a-n and transmitting polarized light 222 directly toward the test device 44 having the sample 46. The test device 44 having the sample 46 reflects the polarized light 222 and directs a diffuse reflection 226 and a specular reflection 230 toward the second polarizer 202b. The second polarizer 202b filters the diffuse reflection 226 and the specular reflection 230 and transmits polarized light 222 toward the camera 26.

The first polarizer 202a having the first transmission axis 206a may filter the unpolarized light 218 and transmit the polarized light 222 directly toward the sample 46, the polarized light 222 being polarized linearly parallel to the first transmission axis 206a. The polarized light 222 may be reflected by the sample 46, producing the diffuse reflection 226 and the specular reflection 230.

The diffuse reflection 226 may be unpolarized or may be polarized in a different direction than the polarized light 222 (i.e., intersecting the first transmission axis 206a). The specular reflection 230 may be polarized in the same direction as the polarized light 222 (i.e., parallel to the first transmission axis 206a).

The diffuse reflection 226 and the specular reflection 230 are both directed toward the second polarizer 202b. The second polarizer 202b may filter the diffuse reflection 226 and the specular reflection 230 and transmit the polarized light 222 directly toward the camera 26, the polarized light 222 being polarized linearly parallel to the second transmission axis 206b.

Inclusion of the first polarizer 202a and the second polarizer 202b is of particular significance where an angle ⊖ provided between the one or more illumination source 42a-n and the camera 26 is relatively small (e.g., about 5 degrees). However, the angle ⊖ may be any angle that allows the reagent analyzer 10a to function in accordance with the present disclosure. For example (but not by way of limitation), the angle ⊖ may be about 10 degrees, about 20 degrees, about 30 degrees, about 40 degrees, about 50 degrees, about 60 degrees, about 70 degrees, about 80 degrees, about 90 degrees, or higher, as well as a range that combines two integers that fall between two of the above-referenced values (i.e. a range from about 13 degrees to about 87 degrees, etc.).

Where the unpolarized light 218 is provided on the first polarizer 202a, the polarized light 222 transmitted by the first polarizer 202a is polarized linearly parallel to the first transmission axis 206a and has an intensity given by

$${I}_{1} = \frac{1}{2} {I}_{0} ,$$

where I₀ is an intensity of the unpolarized light 218.

Where the polarized light 222 is provided on the second polarizer 202b, light transmitted by the second polarizer 202b is polarized linearly parallel to the second transmission axis 206b and has an intensity given by I₂ = I₁ cos² Φ, where Φ is an angle between the polarization of the polarized light 222 and the second transmission axis 206b. Where the polarization of the polarized light 222 is substantially perpendicular to the second transmission axis 206b (i.e., Φ ≈ 90°), as is shown in FIG. 11, the intensity of the light transmitted by the second polarizer 202b is I₂ = I₁ cos²(90°) = 0, and the second polarizer 202b transmits none of the polarized light 222.

In one embodiment, the second transmission axis 206b is substantially perpendicular to the first transmission axis 206a. Therefore, the polarization of the specular reflection 230 may be substantially perpendicular to the second transmission axis 206b while the polarization of the diffuse reflection 226 is not, allowing a portion of the diffuse reflection 226 to pass through the second transmission axis 206b while blocking the specular reflection 230. In another embodiment, the second polarizer 202b is movable (e.g., rotatable) such that the orientation of the second transmission axis 206b may be adjusted to absorb more or less of the diffuse reflection 226 and/or the specular reflection 230.

In some embodiments, the test device 44 includes one or more reagent pad on a reagent card or a reagent strip. In some cases, a portion of the sample 46 pools or remains on the surface of the test device 44 (e.g., reagent pad) producing a specular reflection 230. By incorporating the first polarizer 202a and the second polarizer 202b, the polarized light 222 may be related only to absorption and scattering of light within the reagent pad of the test device 44 providing an improved reading with respect to analyte concentration.

The following is a number list of non-limiting illustrative embodiments of the inventive concept disclosed herein:
1. A method, comprising:
   positioning a wet reagent test device in a field of view of a camera sensor, the field of view of the camera sensor passing through an opening extending between a first major surface and a second major surface of a substrate of a circuit board, the wet reagent test device having a volume of a sample deposited thereon such that a reagent in the wet reagent test device may react with a target constituent if such target constituent is present in the sample;
   illuminating the wet reagent test device with light generated by a plurality of light sources mounted on the second major surface of the substrate of the circuit board, a portion of the light being a reflectance optical signal formed by the light reflecting off of the wet reagent test device pad and passing through the opening in the substrate of the circuit board; and
   detecting the reflectance optical signal by the camera sensor so as to generate an image of at least a portion of the reagent pad.
2. The method of illustrative embodiment 1, further comprising analyzing the image by a processor executing processor executable code stored in a non-transitory computer readable medium to determine a presence or an absence of the target constituent being in the sample.
3. The method of illustrative embodiment 2, wherein analyzing the image by the processor executing processor executable code is defined further as analyzing pixels within the image for a predetermined color indicative of the presence of the target constituent being in the sample.
4. The method of any one of illustrative embodiments 1-3, wherein illuminating the wet reagent test device with light generated by a plurality of light sources is defined further as supplying a level of electricity to each of the light sources such that each light source contributes to illumination at an amount calculated to provide a controlled illumination at the wet reagent test device.
5. The method of illustrative embodiment 4, wherein the controlled illumination is illumination with a substantially uniform intensity at the wet reagent test device.
6. The method of illustrative embodiment 4, wherein the controlled illumination is a designed intensity at the wet reagent test device.
7. The method of any one of illustrative embodiments 4-6, wherein the substrate has a first side, a second side opposite the first side, and an intermediate region between the first side and the second side, and wherein a first group of the light sources are positioned adjacent to the first side of the substrate, and a second group of the light sources are positioned within the intermediate region of the substrate, and wherein illuminating the wet reagent test device with light includes providing a first amount of electricity to the first group of the light sources, and a second amount of electricity to the second group of the light sources, wherein the first amount of electricity is greater than the second amount of electricity.
8. The method of illustrative embodiment 7, wherein the first amount of electricity operates a first light source within the first group of the light sources at a first brightness, and the second amount of electricity operates a second light source within the second group of the light sources at a second brightness, with the first brightness greater than the second brightness.
9. The method of any one of illustrative embodiments 1-8, wherein the light sources are arranged in a planar relationship.
10. The method of any one of illustrative embodiments 1-9, further comprising:
   directing the light onto a first boundary of a first polarizer, the first polarizer having a first transmission axis and being configured to transmit from a second boundary of the first polarizer a portion of the light that is polarized in a direction parallel to the first transmission axis; and
   directing the reflectance optical signal onto a third boundary of a second polarizer, the second polarizer having a second transmission axis and being configured to transmit from a fourth boundary of the second polarizer a portion of the reflectance optical signal that is polarized in a direction parallel to the second transmission axis.
11. The method of illustrative embodiment 10, wherein the second transmission axis of the second polarizer is substantially perpendicular to the first transmission axis of the first polarizer.
12. The method of illustrative embodiment 10, wherein the second polarizer is movably attached to the camera sensor such that the second transmission axis of the second polarizer is adjustable.
13. A reagent analyzer, comprising:
   a circuit board having a substrate, and a plurality of conductive leads extending on or in the substrate, the substrate having a first major surface and a second major surface, the first major surface being opposite the second major surface, the substrate having an opening extending between the first major surface and the second major surface,
   an imaging system having a field of view extending through the opening formed in the substrate and configured to capture an image of a wet reagent test device positioned at a read position in the field of view, the image having a plurality of pixels; and
   a processor configured to receive the image, and analyze pixels of the image to determine a presence or an absence of a target constituent being in a sample applied to the wet reagent pad.
14. The reagent analyzer of illustrative embodiment 13, wherein the first major surface faces the imaging system, and further comprising a light source attached to the second major surface of the substrate.
15. The reagent analyzer of illustrative embodiment 14, wherein the light source is a first light source, and wherein the reagent analyzer further comprises a second light source, and circuitry configured to supply electricity to the first and second light sources such that the first and second light sources contribute to illumination of the wet reagent test device at an amount calculated to provide a controlled illumination.
16. The reagent analyzer of illustrative embodiment 15, wherein the controlled illumination is a substantially uniform intensity.
17. The reagent analyzer of illustrative embodiment 15, wherein the substrate has a first side, a second side opposite the first side, and an intermediate region between the first side and the second side, and wherein the first light source is positioned adjacent to the first side of the substrate, and the second light source is positioned within the intermediate region of the substrate, the circuitry configured to provide a first amount of electricity to the first light source, and a second amount of electricity to the second light source, wherein the first amount of electricity is greater than the second amount of electricity.
18. The reagent analyzer of illustrative embodiment 17, wherein the first amount of electricity operates the first light source at a first brightness, and the second amount of electricity operates the second light source at a second brightness, with the first brightness greater than the second brightness.
19. The reagent analyzer of illustrative embodiment 14, wherein the second major surface of the substrate is planar.
20. The reagent analyzer of illustrative embodiment 14, wherein the opening is a first opening, and further comprising:
   a first polarizer having a first transmission axis, a first boundary facing the light source such that light generated by the light source is incident on the first boundary, a second boundary facing the wet reagent test device, and a second opening extending between the first boundary and the second boundary, the first polarizer being configured to transmit from the second boundary a portion of the light generated by the light source that is polarized in a direction parallel to the first transmission axis, the first opening overlapping the second opening; and
   a second polarizer having a second transmission axis, a third boundary facing the first opening of the substrate such that light reflected by the wet reagent device is incident on the third boundary, and a fourth boundary facing the imaging system, the second polarizer being configured to transmit from the fourth boundary a portion of the light reflected by the wet reagent device that is polarized in a direction parallel to the second transmission axis.
21. The reagent analyzer of illustrative embodiment 20, wherein the second transmission axis of the second polarizer is substantially perpendicular to the first transmission axis of the first polarizer.
22. The reagent analyzer of illustrative embodiment 21, wherein the second polarizer is movably attached to the imaging system such that the second transmission axis of the second polarizer is adjustable.
23. An apparatus, comprising:
   a housing surrounding a cavity, the housing being opaque to visible light;
   a camera sensor having a field of view within the cavity;
   a sample tray positioned within the cavity, the sample tray having a sample holder within the field of view of the camera sensor, the sample tray being positioned a distance away from the camera sensor;
   a circuit board positioned within the cavity between the camera sensor and the sample tray, the circuit board having a substrate, and a plurality of conductive leads extending on or in the substrate, the substrate having a first major surface facing the camera sensor and a second major surface facing the sample tray, the first major surface being opposite of the second major surface, the substrate having an opening extending between the first major surface and the second major surface, the opening positioned within the field of view of the camera sensor so that the field of view of the camera passes through the opening so as to provide the camera sensor with a controlled view of the sample holder of the sample tray;
   a light source attached to the second major surface of the substrate, and connected to at least a portion of the plurality of conductive leads extending on the substrate; and
   circuitry attached to the conductive leads and configured to supply electricity via the conductive leads to the light source.
24. The apparatus of illustrative embodiment 23, wherein the light source comprises multiple light sources arranged and supported in a planar configuration.
25. The apparatus of illustrative embodiment 24, wherein the second major surface of the substrate is planar.
26. The apparatus of any one of illustrative embodiments 24-25, wherein the circuitry is configured to supply electricity to each of the light sources such that each light source contributes to illumination of the sample holder of the sample tray at an amount calculated to provide controlled illumination at the sample holder.
27. The apparatus of illustrative embodiment 26, wherein the controlled illumination is a substantially uniform intensity across an extent of the sample tray.
28. The apparatus of illustrative embodiment 24, wherein the substrate has a first side, a second side opposite the first side, and an intermediate region between the first side and the second side, and wherein a first group of the light sources are positioned adjacent to the first side of the substrate, and a second group of the light sources are positioned within the intermediate region of the substrate, the circuitry provides a first amount of electricity to the first group of the light sources, and a second amount of electricity to the second group of the light sources, wherein the first amount of electricity is greater than the second amount of electricity.
29. The apparatus of illustrative embodiment 28, wherein the first amount of electricity operates a first light source within the first group of the light sources at a first brightness, and the second amount of electricity operates a second light source within the second group of the light sources at a second brightness, with the first brightness greater than the second brightness.
30. The apparatus of any one of illustrative embodiments 23-29, wherein the sample holder has a first major axis and a first minor axis, and wherein the opening in the substrate has a second major axis parallel to the first major axis.
31. The apparatus of any one of illustrative embodiments 23-30, wherein the opening is a first opening, and further comprising:
   a first polarizer positioned within the cavity between the light source and the sample tray, the first polarizer having a first transmission axis, a first boundary facing the light source such that light generated by the light source is incident on the first boundary, a second boundary facing the sample tray, and a second opening extending between the first boundary and the second boundary, the first polarizer being configured to transmit from the second boundary a portion of the light generated by the light source that is polarized in a direction parallel to the first transmission axis; and
   a second polarizer attached to the camera sensor, the second polarizer having a second transmission axis, a third boundary facing the first opening of the substrate such that light reflected by the sample tray is incident on the third boundary, and a fourth boundary facing the camera sensor, the second polarizer being configured to transmit from the fourth boundary a portion of the light reflected by the sample tray that is polarized in a direction parallel to the second transmission axis.
32. The apparatus of illustrative embodiment 31, wherein the second transmission axis of the second polarizer is substantially perpendicular to the first transmission axis of the first polarizer.
33. The apparatus of illustrative embodiment 32, wherein the second polarizer is movably attached to the camera sensor such that the second transmission axis of the second polarizer is adjustable.
34. An apparatus, comprising:
   a circuit board having a substrate, the substrate having a first major surface and a second major surface, the first major surface being opposite the second major surface, and a first opening extending between the first major surface and the second major surface;
   a light source attached to the second major surface of the substrate;
   a first polarizer having a first transmission axis, a first boundary facing the light source, a second boundary opposite the first boundary, and a second opening extending between the first boundary and the second boundary, the second opening overlapping the first opening;
   a camera sensor having a field of view extending through the first opening formed in the substrate and the second opening formed in the first polarizer;
   a sample tray having a sample holder within the field of view of the camera sensor, the sample tray being positioned a distance away from the camera sensor; and
   a second polarizer having a second transmission axis substantially perpendicular to the first transmission axis, the second polarizer being attached to the camera sensor.

It is to be understood that the steps disclosed herein may be performed simultaneously or in any desired order. For example, one or more of the steps disclosed herein may be omitted, one or more steps may be further divided in one or more sub-steps, and two or more steps or sub-steps may be combined in a single step, for example. Further, in some exemplary embodiments, one or more steps may be repeated one or more times, whether such repetition is carried out sequentially or interspersed by other steps or sub-steps. Additionally, one or more other steps or sub-steps may be carried out before, after, or between the steps disclosed herein, for example.

It is to be understood that while the inventive concepts disclosed herein are described in connection with detecting a reflectance value of reagent pads, in some exemplary embodiments of the instant inventive concept, an absorbance value, a transmittance value, or any other value or property relating to a color or a color change of a reagent pad may be used to calculate calibration.

From the above description, it is clear that the inventive concepts disclosed herein are well adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the scope of the inventive concepts disclosed and as defined in the appended claims.

What is claimed is:

1. A method, comprising:
positioning a wet reagent test device in a field of view of a camera sensor, the field of view of the camera sensor passing through an opening extending between a first major surface and a second major surface of a substrate of a circuit board, the wet reagent test device having a volume of a sample deposited thereon such that a reagent in the wet reagent test device may react with a target constituent if such target constituent is present in the sample;
illuminating the wet reagent test device with light generated by a plurality of light sources mounted on the second major surface of the substrate of the circuit board, a portion of the light being a reflectance optical signal formed by the light reflecting off of the wet reagent test device pad and passing through the opening in the substrate of the circuit board; and
detecting the reflectance optical signal by the camera sensor so as to generate an image of at least a portion of the reagent pad.

2. The method of claim 1, further comprising analyzing the image by a processor executing processor executable code stored in a non-transitory computer readable medium to determine a presence or an absence of the target constituent being in the sample.

3. The method of claim 2, wherein analyzing the image by the processor executing processor executable code is defined further as analyzing pixels within the image for a predetermined color indicative of the presence of the target constituent being in the sample.

4. The method of claim 1, wherein illuminating the wet reagent test device with light generated by a plurality of light sources is defined further as supplying a level of electricity to each of the light sources such that each light source contributes to illumination at an amount calculated to provide a controlled illumination at the wet reagent test device.

5. The method of claim 4, wherein the controlled illumination is illumination with a substantially uniform intensity at the wet reagent test device.

6. The method of claim 4, wherein the controlled illumination is a designed intensity at the wet reagent test device.

7. The method of claim 4, wherein the substrate has a first side, a second side opposite the first side, and an intermediate region between the first side and the second side, and wherein a first group of the light sources are positioned adjacent to the first side of the substrate, and a second group of the light sources are positioned within the intermediate region of the substrate, and wherein illuminating the wet reagent test device with light includes providing a first amount of electricity to the first group of the light sources, and a second amount of electricity to the second group of the light sources, wherein the first amount of electricity is greater than the second amount of electricity.

8. The method of claim 7, wherein the first amount of electricity operates a first light source within the first group of the light sources at a first brightness, and the second amount of electricity operates a second light source within the second group of the light sources at a second brightness, with the first brightness greater than the second brightness.

9. The method of claim 1, wherein the light sources are arranged in a planar relationship.

10. The method of claim 1, further comprising:
directing the light onto a first boundary of a first polarizer, the first polarizer having a first transmission axis and being configured to transmit from a second boundary of the first polarizer a portion of the light that is polarized in a direction parallel to the first transmission axis; and
directing the reflectance optical signal onto a third boundary of a second polarizer, the second polarizer having a second transmission axis and being configured to transmit from a fourth boundary of the second polarizer a portion of the reflectance optical signal that is polarized in a direction parallel to the second transmission axis.

11. The method of claim 10, wherein the second transmission axis of the second polarizer is substantially perpendicular to the first transmission axis of the first polarizer.

12. The method of claim 10, wherein the second polarizer is movably attached to the camera sensor such that the second transmission axis of the second polarizer is adjustable.

13. A reagent analyzer, comprising:
a circuit board having a substrate, and a plurality of conductive leads extending on or in the substrate, the substrate having a first major surface and a second major surface, the first major surface being opposite the second major surface, the substrate having an opening extending between the first major surface and the second major surface,
an imaging system having a field of view extending through the opening formed in the substrate and configured to capture an image of a wet reagent test device positioned at a read position in the field of view, the image having a plurality of pixels; and
a processor configured to receive the image, and analyze pixels of the image to determine a presence or an absence of a target constituent being in a sample applied to the wet reagent pad.

14. The reagent analyzer of claim 13, wherein the first major surface faces the imaging system, and further comprising a light source attached to the second major surface of the substrate.

15. The reagent analyzer of claim 14, wherein the light source is a first light source, and wherein the reagent analyzer further comprises a second light source, and circuitry configured to supply electricity to the first and second light sources such that the first and second light sources contribute to illumination of the wet reagent test device at an amount calculated to provide a controlled illumination.

16. The reagent analyzer of claim 15, wherein the controlled illumination is a substantially uniform intensity.

17. The reagent analyzer of claim 15, wherein the substrate has a first side, a second side opposite the first side, and an intermediate region between the first side and the second side, and wherein the first light source is positioned adjacent to the first side of the substrate, and the second light source is positioned within the intermediate region of the substrate, the circuitry configured to provide a first amount of electricity to the first light source, and a second amount of electricity to the second light source, wherein the first amount of electricity is greater than the second amount of electricity.

18. The reagent analyzer of claim 17, wherein the first amount of electricity operates the first light source at a first brightness, and the second amount of electricity operates the second light source at a second brightness, with the first brightness greater than the second brightness.

19. The reagent analyzer of claim 14, wherein the second major surface of the substrate is planar.

20. The reagent analyzer of claim 14, wherein the opening is a first opening, and further comprising:
a first polarizer having a first transmission axis, a first boundary facing the light source such that light generated by the light source is incident on the first boundary, a second boundary facing the wet reagent test device, and a second opening extending between the first boundary and the second boundary, the first polarizer being configured to transmit from the second boundary a portion of the light generated by the light source that is polarized in a direction parallel to the first transmission axis, the first opening overlapping the second opening; and
a second polarizer having a second transmission axis, a third boundary facing the first opening of the substrate such that light reflected by the wet reagent device is incident on the third boundary, and a fourth boundary facing the imaging system, the second polarizer being configured to transmit from the fourth boundary a portion of the light reflected by the wet reagent device that is polarized in a direction parallel to the second transmission axis.

21. The reagent analyzer of claim 20, wherein the second transmission axis of the second polarizer is substantially perpendicular to the first transmission axis of the first polarizer.

22. The reagent analyzer of claim 21, wherein the second polarizer is movably attached to the imaging system such that the second transmission axis of the second polarizer is adjustable.

23. An apparatus, comprising:
a housing surrounding a cavity, the housing being opaque to visible light;
a camera sensor having a field of view within the cavity;
a sample tray positioned within the cavity, the sample tray having a sample holder within the field of view of the camera sensor, the sample tray being positioned a distance away from the camera sensor;
a circuit board positioned within the cavity between the camera sensor and the sample tray, the circuit board having a substrate, and a plurality of conductive leads extending on or in the substrate, the substrate having a first major surface facing the camera sensor and a second major surface facing the sample tray, the first major surface being opposite of the second major surface, the substrate having an opening extending between the first major surface and the second major surface, the opening positioned within the field of view of the camera sensor so that the field of view of the camera passes through the opening so as to provide the camera sensor with a controlled view of the sample holder of the sample tray;
a light source attached to the second major surface of the substrate, and connected to at least a portion of the plurality of conductive leads extending on the substrate; and
circuitry attached to the conductive leads and configured to supply electricity via the conductive leads to the light source.

24. The apparatus of claim 23, wherein the light source comprises multiple light sources arranged and supported in a planar configuration.

25. The apparatus of claim 24, wherein the second major surface of the substrate is planar.

26. The apparatus of claim 24, wherein the circuitry is configured to supply electricity to each of the light sources such that each light source contributes to illumination of the sample holder of the sample tray at an amount calculated to provide controlled illumination at the sample holder.

27. The apparatus of claim 26, wherein the controlled illumination is a substantially uniform intensity across an extent of the sample tray.

28. The apparatus of claim 24, wherein the substrate has a first side, a second side opposite the first side, and an intermediate region between the first side and the second side, and wherein a first group of the light sources are positioned adjacent to the first side of the substrate, and a second group of the light sources are positioned within the intermediate region of the substrate, the circuitry provides a first amount of electricity to the first group of the light sources, and a second amount of electricity to the second group of the light sources, wherein the first amount of electricity is greater than the second amount of electricity.

29. The apparatus of claim 28, wherein the first amount of electricity operates a first light source within the first group of the light sources at a first brightness, and the second amount of electricity operates a second light source within the second group of the light sources at a second brightness, with the first brightness greater than the second brightness.

30. The apparatus of claim 23, wherein the sample holder has a first major axis and a first minor axis, and wherein the opening in the substrate has a second major axis parallel to the first major axis.

31. The apparatus of claim 23, wherein the opening is a first opening, and further comprising:
a first polarizer positioned within the cavity between the light source and the sample tray, the first polarizer having a first transmission axis, a first boundary facing the light source such that light generated by the light source is incident on the first boundary, a second boundary facing the sample tray, and a second opening extending between the first boundary and the second boundary, the first polarizer being configured to transmit from the second boundary a portion of the light generated by the light source that is polarized in a direction parallel to the first transmission axis; and
a second polarizer attached to the camera sensor, the second polarizer having a second transmission axis, a third boundary facing the first opening of the substrate such that light reflected by the sample tray is incident on the third boundary, and a fourth boundary facing the camera sensor, the second polarizer being configured to transmit from the fourth boundary a portion of the light reflected by the sample tray that is polarized in a direction parallel to the second transmission axis.

32. The apparatus of claim 31, wherein the second transmission axis of the second polarizer is substantially perpendicular to the first transmission axis of the first polarizer.

33. The apparatus of claim 32, wherein the second polarizer is movably attached to the camera sensor such that the second transmission axis of the second polarizer is adjustable.

34. An apparatus, comprising:
a circuit board having a substrate, the substrate having a first major surface and a second major surface, the first major surface being opposite the second major surface, and a first opening extending between the first major surface and the second major surface;
a light source attached to the second major surface of the substrate;
a first polarizer having a first transmission axis, a first boundary facing the light source, a second boundary opposite the first boundary, and a second opening extending between the first boundary and the second boundary, the second opening overlapping the first opening;
a camera sensor having a field of view extending through the first opening formed in the substrate and the second opening formed in the first polarizer;
a sample tray having a sample holder within the field of view of the camera sensor, the sample tray being positioned a distance away from the camera sensor; and
a second polarizer having a second transmission axis substantially perpendicular to the first transmission axis, the second polarizer being attached to the camera sensor.
